(19) United States
(12) Patent Application Publication
(10) Pub. No.: US 2008/0209575 A1
(43) Pub. Date: Aug. 28, 2008

(54) License Management in a Privacy Preserving Information Distribution System

(75) Inventors: Claudine Viegas Conrado, Eindhoven (NL); Milan Petkovic, Eindhoven (NL); Willem Jonker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,691

(22) PCT Filed: May 24, 2005
(86) PCT No.: PCT/IB05/51680

§ 371 Date: Nov. 28, 2006

(30) Foreign Application Priority Data
May 28, 2004 (EP) 04102411.8

(51) Int. Cl. G06F 1/00

(52) U.S. Cl. 726/29

(57) ABSTRACT

A system and method for transferring licenses from a first user to one or several other users in an information distribution system, while providing privacy for said users. The level of privacy is enhanced by the license format and the use of a master license, an anonymous license and by the inclusion of a revocation lists in the certificate corresponding to a license.

The present invention relates to information distribution systems, wherein users can request digital information, and more particularly to information distribution systems protecting user information.

At the present time, an individual is required to reveal his identity when engaging in a wide range of activities. Typically, when he uses a credit card, makes a telephone call, pays his taxes, subscribes to a magazine or buys something over the internet using a credit or debit card, an identifiable record of each transaction is created and recorded in a computer database somewhere. In order to obtain a service or make a purchase, using something else than cash, organizations require that he identifies himself.

Consumer polls have repeatedly shown that individuals value their privacy and are concerned about the fact that so much personal information is routinely stored in computer databases over which they have no control. Protecting one's identity goes hand in hand with the option to remain anonymous, a key component of privacy. While advances in information and communications technology have fueled the ability of organizations to store massive amount of personal data, this has increasingly jeopardized the privacy of those whose information is being collected. In an increasingly privacy-aware world, disclosure of personal information and possibilities of user tracking, may create a number of privacy concerns on the users' side and eventually, perhaps, even an increased animosity on the part of those users towards new technologies that are privacy invasive.

This is in glaring contrast to the interest of the service providers or information distributors, who want to know as much about their users as possible, in order to be able to perform as directed marketing campaigns as possible, to protect themselves against fraud, etc. As a measure of precaution, a user who has misused the systems must be precluded from the system in the future.

In many information distribution systems it is relatively easy to learn the habits of different users, for example by tapping the communication within the system. This information can later be misused, for example for spamming. Today these problems are partially solved by, for example, urging the users to pay close attention to how they store for example their secret codes used in the system, or by protecting valuable information by a high degree of security. US 2003/0200468 A1 describes how to preserve the customer identities in on-line transactions, by storing the user's identity at a trusted web site.

However, the above-mentioned system, using a secure web site is vulnerable. Someone who succeeds in attacking the trusted web site, possesses the knowledge of which keys correspond to which user identity. The attacker can then use this information to map the habits of a certain user, in the less protected information distribution system.

A user of a privacy preserving information distribution system might want to distribute a license he owns, which describes rights related to certain requested information. In this document the term “distribute” relates to two sorts of actions. One is giving away or selling a license to another user, which means that the original owner does not possess the license any more, instead it is transferred to the other user. The other is sharing the rights with one or several other users, which all belong to a certain group or domain. When a user has shared his rights with another user, both users possesses one license each, which they are free to use. The rights associated to the respective licenses do not necessarily have to be equal. For example, the rights associated to the transferred rights can be more restrictive than the original ones.

A problem related to distributing rights within a system, is to provide a system wherein a license can be distributed from one user to one or several others, while the privacy of the users is preserved.

It is an object of the present invention to eliminate, or at least alleviate, the described problem related to distributing rights or licenses from at least one user to at least one other user in an information distribution system, while providing privacy for said users.

This object is achieved by a method, and system in accordance with the appended claims 1 and 15. Preferred embodiments are defined in the dependent claims.

As used herein the term “the actual identity of a user” refers to the physical identity of a user or data which can be linked to the physical user, such as a telephone number, an address, a social security or insurance number, a bank account number, a credit card number, an organization number or the like. Further, as used herein, a “pseudonym” or an additional identity is any data, anonymous enough to prevent it from being linked to the actual identity of a person. That there is no link between the actual identity of a user and the information requested by said user, means that there is no obvious way to reconstruct which actual user has requested what information, for example because there are no databases storing information that would enable such a reconstruction.

According to a first aspect thereof, the invention relates to a method for managing licenses and certificates, belonging to at least one user, in an information distribution system, while keeping the identity of said user secret. In said system each user is represented by at least one user identity device, which comprises at least a first persistent pseudonym. The method comprises the following steps:

receiving, at a license managing device, data representing requested information and corresponding rights;

creating, at said license managing device, a first license for said requested information;

receiving, at a first user identity device, said first license;

receiving, at said license managing device, a set of persistent pseudonyms comprising at least one persistent pseudonym, a second license based on said first license and a request to assign said second license to a set of user identity devices, comprising at least one user identity device, each associated with a respective persistent pseudonym comprised in said set of persistent pseudonyms;

creating, at said license managing device, a set of licenses for said requested information, wherein said set comprises a third license for each user identity device of said set of user identity devices, and wherein each license comprises identity data usable to identify said respective third license;

receiving, at an identity managing device, a request for a certificate and a second persistent pseudonym, contained in said set of persistent pseudonyms, from a second user identity device corresponding to said second persistent pseudonym and contained in said set of user identity devices;

creating a certificate, at said identity managing device;

receiving, at said second user identity device, said certificate from said identity managing device;

distributing each of said created licenses in said set of licenses to its corresponding user identity device comprised in said set of user identity devices; and

verifying a license, comprised in said set of licenses, and said certificate at access of said requested information.

According to a second aspect thereof the invention relates to an information system for distribution of information, while keeping the identity of a user secret, comprising:

a first user identity device, comprising a persistent pseudonym;

a set of user identity devices, comprising at least one user identity device;

a license managing device, arranged to receive data representing requested information and corresponding rights from said first user identity device, to create a first license, to send said first license to said first user identity device, to receive a second license based on said first license and a set of persistent pseudonyms comprising at least one persistent pseudonym, to create a set of licenses wherein said set comprises a third license for each user identity device, which device is associated with the respective persistent pseudonym comprised in said second set of persistent pseudonyms, and to distribute each of said licenses comprised in said set of licenses to its corresponding user identity devices;

an identity managing device, arranged to receive a persistent pseudonym, create a certificate and to send a certificate to said user identity device comprised in said set of user devices.

One advantage of the aspects mentioned above, is that licenses can be distributed from one user to one or several different other users, without revealing the actual identities of any of the users to the system. Hence, the privacy of the user is maintained, as the actual identity of said user is not associated with the identifiers in the system. Consequently, monitoring of the behavior of a user in the information distribution system is prevented.

Below, a number of advantages related to different embodiments of the invention are listed. Common for all of these is that the methods described keep the identity of the user secret to the system.

The method, as defined in claim 2, wherein a master license is used when distributing licenses to a domain, advantageously provides privacy for the domain structure, in that no parties (except perhaps the one that is responsible for the creation of the domains and the likes) is able to link the domain members (or their identifiers) with the domains identifier. Further the introduction of a second license managing device, or a domain manager, provides a privacy enhanced management of countable rights, in that the content provider is prevented from learning when spending of countable rights occurs, which identifier is involved, what content and which device was used. By introducing several domain managers, e.g. one per domain, no device has a full knowledge of which information that is used by which devices. Further, this method is advantageous when managing countable rights while preserving the privacy of the users. Through this method behavioral privacy toward the first license managing device is achieved. That is, the first license managing device does not learn the time, requested information, user identity device and persistent pseudonym for each user action that involves changing of countable rights.

The method, as defined in claim 3, advantageously provides a secure license structure.

The method, as defined in claim 4, advantageously provides a higher level of security, as it demands that both the user identity device license and the master license is verified before access to a requested content is provided. In this verification process the rights comprised in said user identity device license can be compared to the rights comprised in said master license, in order to determine that the rights comprised in the master license is not more restricted than the rights comprised in said user identity device license.

The method, as defined in claim 5, advantageously facilitates verification of the validity of a license by providing an indication of which licenses that are valid in corresponding certificates. It is understood that the act of “indicating which licenses that are valid” can be performed both in a positive and a negative manner. One example of the latter, is to use a revocation list, or black list, which comprises all licenses that are no longer valid. An example of the former is to use a white list, comprising all valid licenses.

The method, as defined in claim 6, advantageously facilitates cancellation of old licenses, when these for example have been transmitted to another user or have become invalid due to other reasons, like mischievous actions.

The method, as defined in claims 5 and 6, has the advantage of providing a secure way of canceling licenses that has ceased being valid. The method ensures that the old license and the new license can not be used at the same time. Further it prevents the device providing the information from knowing the connection between the old and the new user of the license.

The method, as defined in claim 7, provides an advantageous way of identifying the licenses. Normally each set of information is encoded with a different key, this key can be comprised in said license and used for decrypting said content. As each license comprises a different key, the key can be used to identify the license. Further, this license identity data facilitates the management of spent, shared or transferred rights.

The method, as defined in claim 8, is an advantageous way of providing integrity. According to this method each license identity data, in the list of licenses indicating valid licenses comprised in a certificate, is encoded with a constant by a hash function. This allows a verifier of a certificate and license to determine whether a license is valid, by comparing said license identity data to a list of encoded license identity data, but no other entity learns any of the license identity data.

The method, as defined in claim 9, provide an advantageous license format, which provides security for the information provider, without revealing the identity of the user to the system.

The method, as defined in claim 10, is advantageous as it facilitates a way to determine that a presented license is valid (not revoked).

The method, as defined in claim 11, is advantageous as no user has to manage any other users keys.

The method, as defined in claim 12, is advantageous as it prevents the system from learning the association between said first and second persistent pseudonyms. This knowledge might be unwanted by the users, as it can be misused for e.g. spamming.

The method, as defined in claim 14, is advantageous as it facilitates a way of providing more restricted rights for said transferred license, compared to the original license. Hence, this method can be used for differentiating the rights between members within a domain.

Some advantages, which are obtained by embodiments of said method, have been described above. Similar advantages can also be achieved by corresponding embodiments of said information distribution system, as defined in the dependent claims related to the system.

These and other aspects of the invention will be apparent from and elucidated with reference to the embodiments described hereinafter.

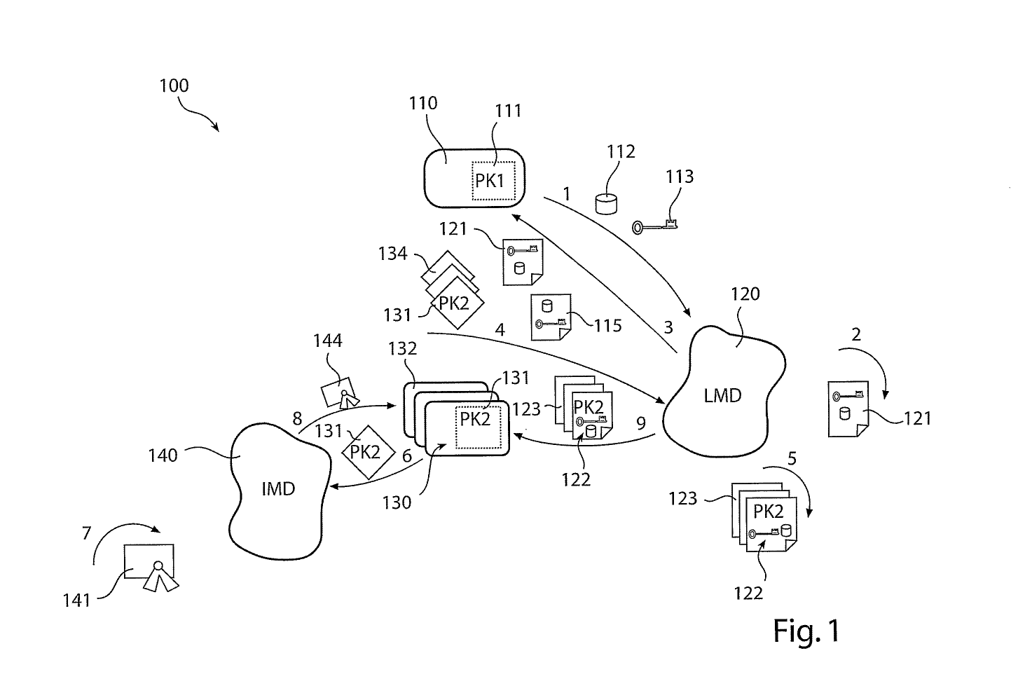

FIG. 1 schematically shows a first embodiment of the present invention, wherein a license is distributed from a first user identity device to at least a second user identity device.

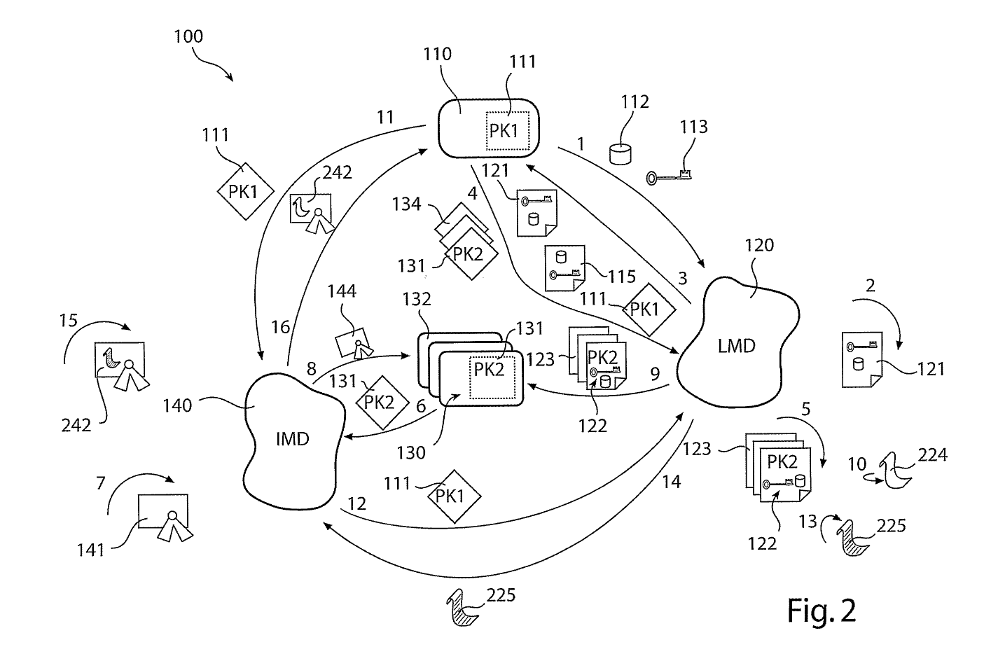

FIG. 2 schematically shows a second embodiment of the present invention, wherein transferred licenses are canceled.

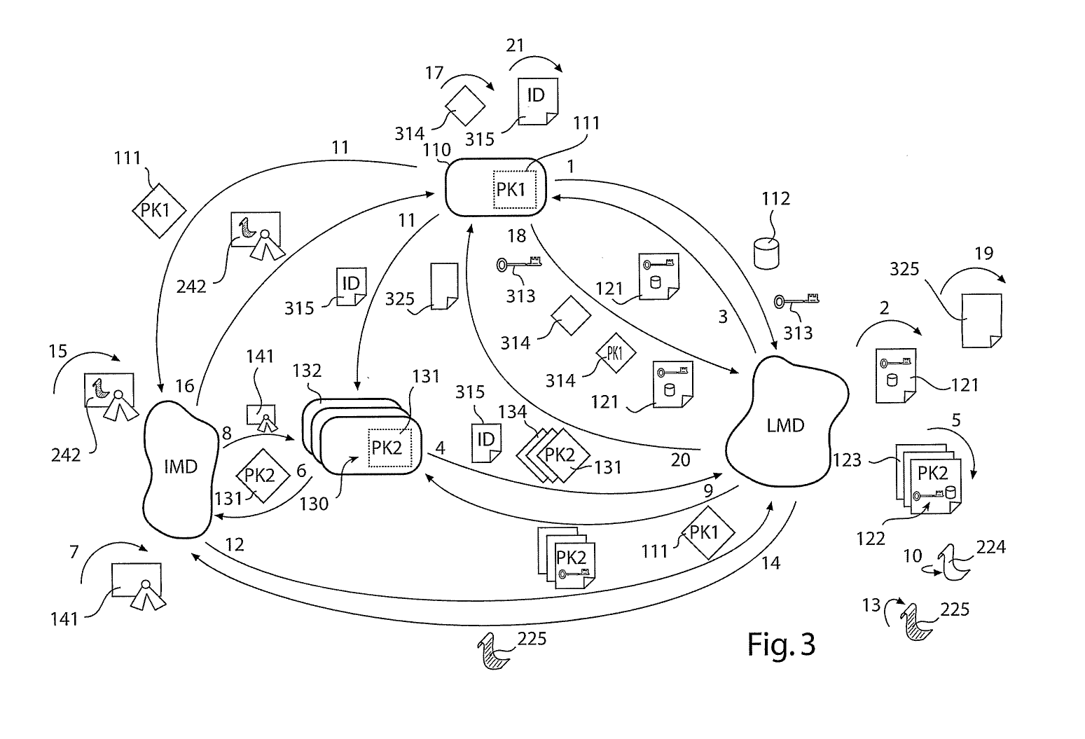

FIG. 3 schematically shows a third embodiment of the present invention, wherein an anonymous license is used when transferring a license from a first to a second user.

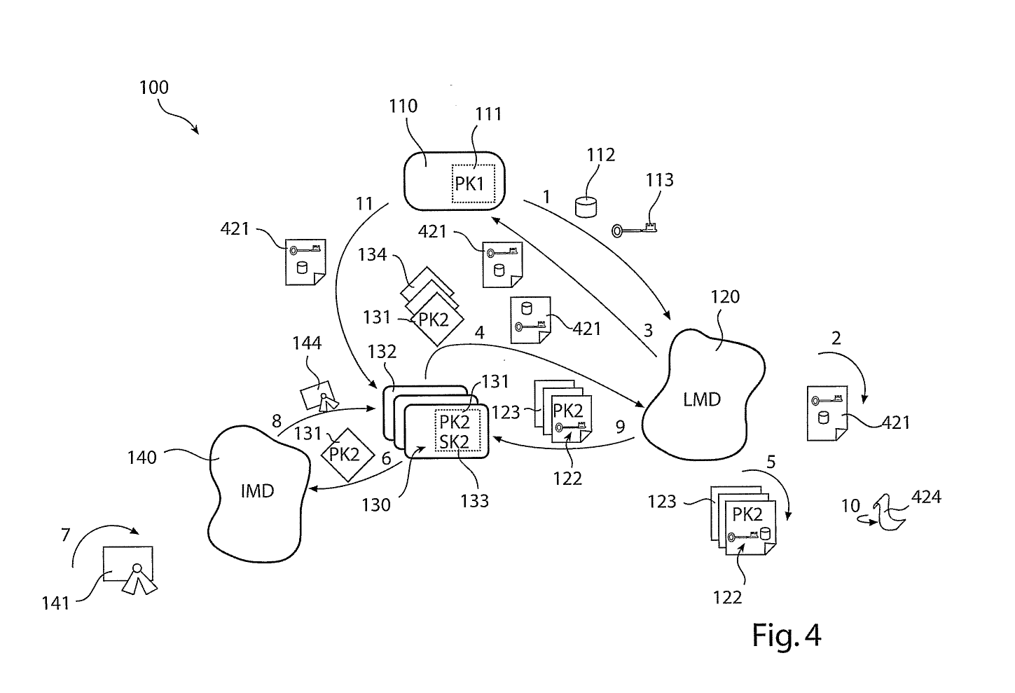

FIG. 4 schematically shows a fourth embodiment of the present invention, wherein an anonymous license is used to transfer rights from a first user to a second user, without a preceding license.

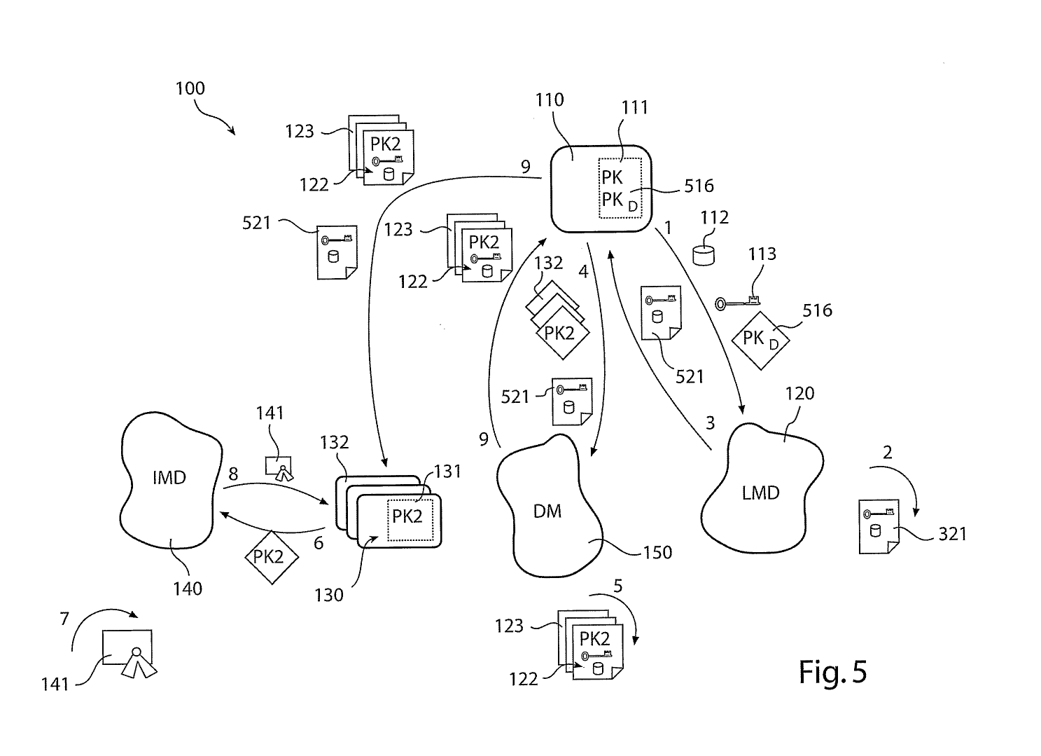

FIG. 5 schematically shows a third embodiment of the present invention, wherein one license is distributed from one user identity device to a set of user identity devices.

FIG. 1 schematically shows an embodiment of the present invention. A user who wants to access information belonging to a content provider or license managing device LMD 120, such as a database connected for example to the Internet, without revealing his actual identity to the information system 100, can do so by using a user identity device or a smart card SC 110. When the user wants to buy rights to access some content, he contacts the content provider or license managing device 120 by means of an anonymous channel requesting the rights 113 and a certain content 112. After an anonymous payment scheme has been conducted, the user sends 1 his public key PK1 111 to the license managing device 110, which then creates 2 the rights and/or license 121 for that content. In different embodiments the content provider and the license managing device can be one common unit or two separate units. If they are two separate units, the content provider sends the requested content to the user, and the license manager device creates the license for that content. If they are one common unit the license manager device provides the user both with the requested content and the license.

The content is encrypted, by the content provider, with a symmetric key SYM and sent to the user together with the license 121. Preferably, the format of the license is {PK1[SYM//Rights//contentID]}_{signCP} where PK1 encrypts the concatenated values [SYM//Rights//contentID]. In this document Rights describe the rights obtained by the user, for example whether he is entitled to listen to a whole song or just an intro, or the number of times he is entitled to listen to the song. Further, contentID identifies the content which is associated to said rights, and signCP is the signature of the content provider on the license 121. An alternative format to provide extra security is: {PK1[SYM//Rights//contentID], H(SYM//Rights//contentID)}_{signCP}, where the full value under the encryption can be checked individually by the accessing device. Note that the accessing device cannot check the full value under the encryption with PK₁, because it does not learn PK₁. The license 121, when inspected, does neither reveal the public key PK1 111, nor the content identifier or the rights, so it preserves the user's privacy with respect to content and rights ownership. Therefore, if the license 121 is found in a user's storage device, it does not compromise the user's privacy. During this buying procedure, which has briefly been described above, the license manager device 120 learns the association between the public key PK1 111 and the contentID 112, the rights 113 and the symmetric key, but it does not learn the real user's identity due to the anonymous channel.

When the user of the first user identity device 110 wants to distribute one of his licenses to a holder of a second user device 130, a corresponding license for said second user device needs to be created. This can be achieved for example through the following procedure. The holder of the license, the first user, uses his user identity device 110 to send 4 the license 121 he wants to distribute together with at least the permanent pseudonym PK2 131 of the user identity device 130 who is to receive the license to the license, managing device 120. The license 121 can have the format {PK1[SYM//Rights/contentID]}_{signCP}, as described above. If the received license is valid, a new, second license 114 is created 5, having the format {PK2[SYM′//Rights′/contentID]}_{signCP} where PK2 131 encrypts the concatenated values [SYM′//Rights′/contentID]. Rights′ describe the rights obtained by the second user, which can be equal to, or more restricted, than Rights. ContentID identifies the content which is associated with said rights, and signCP is the signature of the content provider on the license 122. The created license 114 is sent 9 to said second user device 130, and is now ready to be used for accessing said content, together with a valid compliance certificate for said second user device.

Typically, in order for said second user to securely access said requested content on an accessing device, a compliance certificate 141 for his smart card 130, must be shown to the accessing device. This compliance is preferably issued before said second license is sent to said second user identity device. Further, the certificate 141 does not, preferably, contain the public key PK1 111, but is issued with a changeable SC pseudonym or a temporary pseudonym. To obtain the compliance certificate 141 for the SC 130, the user/SC contacts the identity managing device 140 or compliance certificate issuer for smart cards (CA-SC) anonymously, sends 6 its public key PK2 131 and asks for a certificate. The CA-SC 140 verifies whether the private key PK2 131 is valid. If that is the case, the CA-SC 140 generates 7 a temporary pseudonym for the smart card 131, for example a random number RAN, and issues the following compliance certificate 141, which is sent 8 to the smart card 131: {H(RAN), PK1[RAN]}_{signCA-SC}. H( ), in this embodiment, is a one-way hash function, PK2 131 encrypts RAN, and sign CA-SC is the signature of the CA-SC on the certificate.

The certificate 141, when inspected, does neither reveal the public key PK2 131, nor the smart card's 130 temporary pseudonym RAN. Moreover, the only entity which can obtain RAN from the certificate 131 is the smart card 130. This is done via decryption with a private key SK2 133, associated with the SC 130. The value RAN may then be checked by a verifier via the hash value in the certificate. The use of a pseudonym RAN allows the verifier to check the compliance of the smart card 130, without learning its public key PK2 131. Moreover, since the pseudonym RAN can be changed as often as required (every time the smart card SC 130 obtains a new compliance certificate 131), the possibility of a verifier to link compliance certificates to a given smart card 110 can be minimized. During the procedure, which has been described above, the compliance certificate issuer for smart cards (CA-SC) 140 learns the association between the public key 131 and RAN, but not the real user's identity due to the anonymous channel.

Now the user can access the content for which he has a license, which is preferably performed on an accessing device AD. Typically the accessing device behaves in accordance with DRM rules. To access the content the user must either carry the content and license with him (e.g. in an optical disk) or have them stored in some location over the network. In either case, the content plus license must first be transferred to the accessing device AD. Moreover, since the user is now physically present in front of the accessing device AD, his actual identity may be “disclosed” to the AD. Therefore, in order to prevent the disclosure of the association, between the actual identity of the user and the public key PK2, to any other than the user, the public key PK2 131 should not be revealed to the accessing device AD at the time of content access. That is the reason why the compliance certificate 141 for the SC 130 is issued with a changeable pseudonym RAN. Upon check of that certificate, the accessing device learns the RAN, but does not learn the public key PK1 131. One example of a content access procedure is described below.

### Content Access Procedure

Before the smart card 130 and the accessing device interact with one another, they do a mutual compliance check: compliance of the accessing device AD is proved by means of an accessing device compliance certificate, which is issued by the compliance certificate issuer for accessing devices (CA-AD), and which is shown to the smart card 130. In order to be able to verify the accessing device compliance certificate, the smart card 130 is provided with a public key of the CA-AD. If this key is changed periodically, that obliges the AD to periodically renew its compliance certificate. This also implies that the smart card SC 130 must renew that key periodically, which can be done at the time that the SC 130 obtains its own compliance certificates from the CA-SC.

Compliance of the smart card 130 is provided by means of the compliance certificate, which is shown to the accessing device. As mentioned above the smart card 130 obtains the value RAN from the certificate 141, by decrypting it with the private key PK2, and sends this value to the accessing device. The accessing device checks this value via the term H(RAN) in the certificate. Since the accessing device can be provided with a clock, the smart card compliance certificate 141 may have its time of issuance added to it, which obliges the smart card 130 to renew the certificate when it gets too old. It is also in the interest of the smart card to renew its compliance certificate often enough, so as to minimize the linkability mentioned above.

After this mutual compliance check, described above, the accessing device sends the term PP[SYM//Rights/contentID] from the license to the smart card 130, which decrypts it and sends the values SYM, Rights and contentID back to the accessing device. The accessing device can then use SYM to decrypt the content and give the user access to it, according to Rights.

### Cancellation of License

FIG. 2 schematically describes a different embodiment of the invention. This embodiment equals the embodiment which was described in relation to FIG. 1, except that the present embodiment comprises the use of a certificate indicating which related licenses that are valid. The first license 121 is issued and sent to the first user identity device 110 as described above, in relation to FIG. 1 reference numerals 1-3. Thereafter the user distributes 11 his license to a second user, who holds the second user identity device 130, and the first license is revoked according to the below described process.

The first user identity device 110 contacts 4 the license managing device 120 via an anonymous channel, authenticates himself by his persistent pseudonym PK1 111, and presents 4 the license 121 to be transferred as well as the persistent pseudonym PK2 131 of the second user identity device 131. The license managing device verifies that the license is valid, by comparing it to a first set of data 224. In this embodiment, this first set of data is a black list, or in other words revocation list, comprising the identities of all licenses that are no longer valid.

If said first license is valid the license manager device 120 proceeds by updating 10 the information system with the information that said first license 121 has been transferred to a second user. This can be done by updating 10 said first set of data 224, such that it indicates that said first license is no longer valid.

The first user is then encouraged to provide 11 his persistent pseudonym 111 and a request for a renewal of his certificate, to said identity managing device 140. After the identity managing device 140 has received the persistent pseudonym 111, the pseudonym is forwarded 12 to said license managing device 120 together with a request for a second set of data, indicating all revoked licenses corresponding to said pseudonym PK1. Since the symmetric key SYM, that encrypts the content, is unique per license, the license managing device can use this value to identify each revoked license associated with PK1 111. The license managing device then creates 13 this second set of data 225 comprising the values:
H(Sym_{—}1//Time),
H(Sym_{—}2//Time),
. . . ,
H(Sym_n//Time),
   where each value is the hash of the key Sym_i of a revoked license, corresponding to said PK1 111, concatenated with the current time. The one-way hash function H( ) is used to reduce the size of each term in the revocation list in said second set of data 225, and also to hide the values of Sym_i from any party which does not need to learn those values. Further, the current time is concatenated with each Sym_i in order to prevent the linkability via the revocation list of compliance certificates issued for PK1 111 in different occasions.

Once the values for all revoked licenses of PK1 are included in the second set of data 225, these data are sent 14 by the license managing device 120 to the identity managing device 140 together with the value Time, i.e. the constant with which the license identity was concatenated. The identity managing device 140 now includes 15 this second set of data, as well as said value Time, in a compliance certificate 242 of said first user identity device. The certificate 242 have the following format: {H(RAN), PK1[RAN], Time, H(Sym_{—}1//Time), H(Sym_{—}2//Time), . . . , H(SYM_n//Time)}_{signCA-SC}.

The certificate 242 is then sent to the first SC 110, which may keep it stored in the SC itself. A typical SC may store a compliance certificate whose revocation list has up to around five hundred revoked licenses. When/if the revocation list becomes too big that storage in the SC is no longer possible, the certificate can be stored, for instance, on a server in the network or on an optical storage medium.

As described above, when a user requests access to content on an accessing device or compliant device CD, the content plus license must be transferred to the accessing device. Since the user identity device must prove its compliance to the accessing device, upon a user's request to content, it must present the compliance certificate described above. So, after the mutual compliance check, the accessing device sends the term PK2[SYM′//Rights′//contentID] from the license to the user identity device, which decrypts it and sends the values SYM′, Rights′ and contentID back to the accessing device. Before the accessing device uses SYM′ to decrypt the content and give the user access to it (according to Rights′), it calculates H(Sym′//Time) and checks whether this value is in the revocation list or not. If it is not, the CD then proceeds with the handling of the access request.

It is an advantage if the compliance certificate is frequently renewed by the user identity device 110. This is done in the interest of both the user and the DRM system for at least the following reasons:

in order to minimize linkability via the pseudonym RAN of the user's content access requests to different content, and

as a requirement of the accessing device, which verifies if the certificate (and therefore the revocation list) is too old via the value Time.

In case the user is not interested in a frequent renewal of his certificate, a renewal can be forced as a requirement of the accessing device. As a consequence of this frequent renewal of compliance certificates, renewed values of revoked licenses of PK1 are also frequently available to the accessing device.

After the certificate 242 has been received 16 by said first user device 110, and shown to license managing device said second license 122 is sent 9 to said second user identity device 131.

A preferred approach would be that the second license is sent to the second user identity device the first user device proves to the license managing device that his old certificate (used before certificate 242 is obtained and therefore not including revoked license)has expired.

One advantage of this process is that the new license is not distributed to the second user until the first user has received his new certificate. In this way the first and second user are prevented from using their respective license at the same time. Keeping the association between the first and second user secret

When the license is transferred from the first to the second user according to e.g. said second embodiment of the invention, the license manager device learns the association between those two users, i.e. the association between the public keys PK1 and PK2. The knowledge of this association may be unwanted by the users. It might therefore be advantageous to use generic licenses, in this document referred to as “anonymous licenses”, in which a user identity is not specified.

An anonymous license is in this document a license for a specified content with specified rights (as the license 122 previously described), but which license is not associated with a user identity device (i.e. with a persistent pseudonym). Such a license can be issued by the license managing device for any anonymous user who pays or otherwise obtains a given content with given rights. It can also be issued for a first user who requests a revocation of his license, in order for it to be transferred to a second user. Since the license is not associated with a given person, it can be transferred (given, sold, etc.) to any other person. This person can later present the license to the same license managing device, to be exchanged for a personalized license (e.g. license 121), which can then be used for content access.

For security reasons, however, before the license managing device issues the anonymous license, a unique identifier must preferably be assigned to it. This is done in order to prevent that, once the anonymous license has been already redeemed, any copy of it (which might be made by the user), can also be redeemed. However, if this identifier is chosen by the license managing device, it will be able to link the persistent pseudonyms of both user, as it could recognize the identifier. In order to prevent that blind signatures can be used as described below.

FIG. 3 illustrates a third embodiment of the invention wherein a first user, who processes a license corresponding to certain content and rights, transfers this license to a second user without revealing the link between said first and second user devices to the system. This third embodiment is equal to said second embodiment, as described in relation to FIG. 2, except for the differences which are described below.

The first license 121 is issued and sent to the first user identity device 110 as described above, in relation to FIG. 1 reference numerals 1-3. Thereafter the first user contacts 18 the CP or license managing device 120 via an anonymous channel and sends the first license 121 and his PK1 111 together with a request for revocation of that license and issuance of an anonymous license. This revocation or cancellation has previously been described, in relation to FIG. 2 reference numerals 11 to 16, but is also discussed in the next paragraph.

The CP 120 sends a request for the user to authenticate himself and this can be achieved via a standard protocol (the CP sends to the user a random challenge encrypted with PK1 111; if the user is authentic, he can use his SK from the pair PK/SK to decrypt the challenge and send it back to the CP). After authentication of the user, the CP cancels the first license 121 of PK1 111. Further, before an anonymous license is sent to said first user identity device 110, a new compliance certificate 241 is sent 16 from the CA-SC to the first user identity device. This certificate 241 includes said first license 121, as said first set of data was modified before said certificate was created.

The first user identity device creates a secret random identifier and blinds 17 this value, which results in a blinded identifier Blind[ID] 314. After the first user identity device has received said new certificate 241, the protocol between the user and the CP can continue. Preferably, a new protocol starts in which the user sends 18 to the CP his PK1 111, the first license 121 and authenticates himself and also sends his new compliance certificate 241 as well as old expired certificate, and said blinded ID Blind[ID] 314 and the NewRights 313, which the user wishes to transfer to the second user. With all these values from the first user, the CP can firstly verify that the new compliance certificate 241 of the first user includes the canceled license 121, (reference via the term H(Sym//time)). Secondly, verify whether NewRights 313 is less or equal than Rights 113, which appear in the first license 121. Thirdly, obtain the contentID 112 from the presented first license 121. If the verification are satisfactory, the content provider CP 120 can then create 19 an anonymous license for said requested content and corresponding rights.

In order to do this the license managing device, has a unique pair of public/private keys for each possible combination of different rights and different content. If the set of all rights is pre-specified comprising R rights and the set of all content has C items. This means that the license managing device preferably must have R*C different pubic/private key pairs. Given this setting, once the license managing device receives the data {Blind[ID], NewRights} from the first user, it can sign 19 the blind identifier, Blind[ID] 314, with the private key for this combination of {NewRights, contentID} and return 20 to the user the value {Blind[ID]}_{signed-NewRights-contentID} 325. The user then un-blinds 21 the signed identifier to obtain {ID }_{signed-NewRights-contentID} 315 and can transfer 11 this value, together with the license specification {NewRights, contentID}, to the second user. The specification of the new rights NewRights, which are to be associated with the anonymous license (in case the license is being transferred between users), is only needed provided that the specified rights allows less than the original rights. The possibility of sending NewRights allows a user to give one of his licenses to another user but with more restrictive rights than the original right he had, if he so wishes.

In order to obtain a personalized license, the second user identity device contacts the license managing device anonymously, authenticates himself with his public pseudonym PK2 131 and sends to the license managing device the signed, unblinded identifier {ID}_{signed-NewRights-contentID} 315 together with {NewRights 313, contentID 316}.

The CP 120 first verifies that the unblinded ID 315 has not been already used (in a list of IDs he keeps), and if not he enters that ID in the list of used IDs. The CP further verifies his signature in the ID 315 (if it indeed was made with the key for {NewRights, contentID}) and if all is correct, the license managing device can finally issue 5 a personalized license 122 to the second user (which is sent 9 to his user identity device 130 together with the content encrypted with a personalized key SYM2):
{PK2[SYM2//NewRights//contentID]}_{signCP} 122.

After the issuance of the license 122 above, the value ID is entered by the license managing device into a set of data, as described above, which is checked by the license manager device every time it receives a request (with a signed identifier) for a personalized license from an anonymous license. This prevents the issuance of a license as a response to a personalized license request for an already redeemed anonymous license.

Anonymous licenses can, apart from being used when a user sells or gives away information to another user, facilitate when an organization for example want to encourage people to by licenses through the “buy one, get a second one for free” model. The second license can be issued as an anonymous license, which can be transferred to any person. A fourth embodiment according to the invention is described in relation to FIG. 4. In this embodiment a first user requests an anonymous license for a certain content and corresponding to certain rights, without wanting to transfer an existing license. The user receives such an anonymous license and transfers this license to a second user identity device, which belongs to a second user. This third embodiment is equal to said third embodiment, as described in relation to FIG. 3, except for the differences which are described below.

As illustrated in FIG. 4, the first user contacts 1 the CP via an anonymous channel with a request for an anonymous license for a given combination of Rights 113 and contentID 112. Possibly he also sends a proof of anonymous payment (such as a token that corresponds to a given amount of money). If the amount paid by the user pays for that given combination of Rights 113 and contentID 112, the license managing device 120 or CP can simply issue 2, for the first user, an anonymous license 421, which for example is a random ID signed by the CP with the key for that given combination. In this fourth embodiment the CP 120 himself can generate the ID 325 directly, as the user contacts the CP anonymously and does not need to reveal his PK, since the license is not issued to him. He only need to prove anonymously that he is entitled to request that content with those rights. Thereafter, the anonymous license 421 is sent 3 to said first user identity device 110, which forwards 11 it to a second user identity device 130, possibly together with said contentID 112 and said Rights 113. The second user identity device then provides 4 said anonymous license 421 and a request for a personalized license, possibly together with said contentID 112 and said Rights 113, to said license managing device 120. The license managing device now, as was described in relation to said third embodiment, creates 5 a personalized license 122 for said second user identity device 130, which is sent 9 to said device 130.

In the solutions described above, the license managing device 120 has to maintain a huge list with R*C different public/private key pairs and the corresponding rights and contentID values. This solution can be simplified with techniques from Identity-based cryptography. Applied to this invention, instead of using the identity of people or different parties to generate the keys, the concatenation of the content identifier, the rights and the name of the license managing device can be used for key generation. In this way, a public key can simply be defined as the string [ContentID//Rights//LMDname] and the corresponding private key is generated based on that string and on a master key generated by the license managing device.

The use of Identity-based cryptography to generate the signing key pairs has the following advantages:

Key management by the license managing device is greatly facilitated given that the license managing device does not need to store the list of all R*C key pairs anymore (a private key can be generated each time it is needed). Even if storage is preferred over computation, only the private keys need to be stored.

The solution allows anyone to check the signature of the license managing device on the anonymous license if they know the content identifier, the rights and the name of the license managing device (since these values make up the public key).

The verification of the signature of the license managing device can be vital, if the second user buys the license from the first user. The second user is interested in knowing that the anonymous license he receives from the first user indeed refers to a given content with given rights, and that the license can be redeemed with a given CP.

Distributing Rights within a Domain

When a user of the information distributing system buys information, other users which he is acquainted to might want to share that information. This can be done by forming a domain, which is associated with a shared domain key PK_{D}. The domain has to be registered with a domain authority, which can verify that indeed the members from a group, e.g. a family. The same domain authority can assign a PK_{D} to that group of users and add an SK_{D} to the smartcard. Having done that, a user can buy content for his personal use (using his personal key PK1) or for the whole domain using the domain key PK_{D}. In the case of buying content for the whole domain, a first user having a first user identity device 110 associated with a public domain key PK_{D} 516, provides 1 this public domain key PK_{D} together with a request for a certain content contentID 112 and Rights 113, to a license managing device 120. The license managing device creates 2 a master license 521, which is sent (3) to the first user identity device. The maser license preferably has the format:

{{PK_{D}[SYM//Rights//contentID},1}_{signCP},MR}_{signCP}. (1)

The master license consists of the domain license, having the format:

{PK_{D}[SYM/Rights//contentID},1}_{signCP}, (2)

and the master rights tag (MR), signed all together by the CP. The domain license consists of a symmetric key SYM, master rights Rights 113, and contentID 112 encrypted by the domain key PK_{D}, as well as a delegation tag (set to 1), signed all together by the CP 120. At the end of the process of obtaining this master license 121 from the CP 120, the user can encrypt the master license, to the following format

PK1 [{{PK_{D}[SYM//Rights//contentID}, 1}_{signCP},MR}_{signCP}], (3)

in order to preserve his privacy towards the domain members who share the PK_{D}. So, no user in the domain will be able to see the license and rights of the user who has bought the content.

The creation of personal user rights (for particular domain members) is done by a Domain Manager device (DM) 150. The user who has bought the content prepares a set of permanent pseudonyms 132 and corresponding rights for particular domain members, and sends 4 it together with the master license 521 to DM. Such a set, or data structure, can have the following format: [PK₁, Rights₁; PK₂, Rights₂; PK₃, Rights₃; . . . PKₙ, Rightsₙ]. Where PKi are the public keys of the domain members (possibly including said first user), while Rightsᵢ are rights expressions, describing the Rights which is to be associated with different PKs. This facilitates a differentiation of rights within a domain. In the interaction with DM the user decrypts the encrypted certificate (3) and consequently the term PK_{D}[Sym//Rights//contentid]. The user might also have to show to the DM certificates proving that all PKᵢ, that are mentioned in the set (for which the user wants to prepare licenses) actually belong to his domain. Then, the DM creates 5 a member license for each PKᵢ having the format:

{PKᵢ[Sym//Rightsᵢ//contentIDᵢ], PK_{DM}}_{signDM}. (4)

Finally, the license managing device distributes 9 these rights to the domain members, preferably via the first user identity device.

When accessing the content, a domain member might have to present to the device both the domain licenses and the personalized license, as well as a compliance certificate for the DM. The reason to present both licenses is to allow the accessing device to verify both that user belongs to the domain (if he knows both PKᵢ and PK_{D}), and also that the rights Rightsᵢ<=Rights.

The procedure described above makes sure that only a user who has bought the content and has the master license can create domain licenses for the domain members. The introduction of the DM as a party who takes care of the user rights within the domain is also beneficial for the management of the countable rights. Now, the DM can issue new licenses and revoke old licenses when the spending of countable rights occurs. In that way the user privacy towards the CP is protected, because the CP is not contacted every time the user spends rights. Therefore, the CP can not create logs that link the user's PK, content identifiers, device identifiers and time when spending of countable rights occurs. However, this solution is also beneficial for the CP, because the revocation of an old license is managed by the DM and therefore it is instant.

Consequently, as described above, the present invention facilitates the distribution of rights within an information distribution system. It is to be noted, that for the purposes of this application, and in particular with regard to the appended claims, the word “comprising” does not exclude other elements or steps, that the word “a” or “an”, does not exclude a plurality, that a single processor or unit may perform the functions of several means, and that at least some of the means can be implemented in either hardware or software, which per se will be apparent to a person skilled in the art.

1. A method for managing licenses and certificates, belonging to at least one user, in a system distributing requested information, while keeping the identity of said user secret, wherein each user is represented by at least one user identity device, which comprises a persistent pseudonym, said method comprising:
receiving at a license managing device, data representing requested information and corresponding rights;
creating at said license managing device, a first license for said requested information;
receiving at a first user identity device, said first license;
receiving at said license managing device, a set of persistent pseudonyms comprising at least one persistent pseudonym, a second license based on said first license and a request to assign said second license to a set of user identity devices, comprising at least one user identity device, each associated with a respective persistent pseudonym comprised in said set of persistent pseudonyms;
creating, at said license managing device, a set of licenses for said requested information, wherein said set comprises a third license for each user identity device of said set of user identity devices, and wherein each license comprises identity data usable to identify said respective third license;
receiving, at an identity managing device, a request for a certificate and a second persistent pseudonym, contained in said set of persistent pseudonyms, from a second user identity device corresponding to said second persistent pseudonym and contained in said set of user identity devices;
creating a certificate, at said identity managing device;
receiving at said second user identity device, said certificate from said identity managing device;
distributing each of said created licenses in said set of licenses to its corresponding user identity device comprised in said set of user identity devices; and
verifying a license, comprised in said set of licenses, and said certificate at access of said requested information.

2. A method according to claim 1, wherein said first user identity device belongs to a first domain of user identity devices, and each user identity device comprised in said set of user identity devices belongs to said first domain, and wherein said first license is a master license, said second license equals said first license, said license managing device comprises a first license managing device and a second license managing device, and said set of persistent pseudonyms comprises persistent pseudonyms all belonging to said first domain, and wherein:
said creating a first license comprises creating at said first license managing device a master license corresponding to said requested information and said rights, which license is distributable within said first domain;
said receiving a set of persistent pseudonyms, a license and a request to assign said license to a set of user identity devices further comprises receiving these from said first identity device;
said creating a set of licenses comprises creating said set of licenses at said second license managing device, wherein each license is useable by a corresponding user identity device when accessing said requested information.

3. A method according to claim 2 wherein:
said receiving data representing requested information and corresponding rights, further comprises receiving a first persistent domain pseudonym associated with said first domain;
said creating a master license further comprises encrypting a first symmetric key, said rights and said data representing said information by said first persistent domain pseudonym, and including this encryption in said master license.

4. A method according to claim 2, wherein said verifying a compliance certificate and one of said licenses comprised in said set of licenses further comprises verifying said license by comparing to said master license.

5. A method according to claim 1, which further comprises:
creating a first set of data indicating which licenses that are valid in such a way that data representing all licenses, which are no longer valid and which have been related to at least one persistent pseudonym, is traceable by that pseudonym, and wherein said creating a certificate associated to a persistent pseudonym further comprises:
receiving at said license managing device, from said identity managing device, said persistent pseudonym and a request for data indicating which licenses, related to said persistent pseudonym, that are valid;
creating at said license managing device, a second set of data indicating which licenses, related to said persistent pseudonym, that are valid;
receiving at said identity managing device, said second set of data from said license managing device; and
including, at said identity managing device, said second set of data in said requested certificate.

6. A method according to claim 5, wherein
said receiving a set of persistent pseudonyms, a license and a request to assign said license to said set of user identity devices further comprises receiving from said first identity device together with said first persistent pseudonym; and
creating a second license further comprises modifying said first set of data such that it indicates that said second license is no longer valid, creating a certificate for said first persistent pseudonym, at said identity managing device, and distributing said created certificate to said first user identity device.

7. A method according to claim 6, wherein each license comprises a different key and said creating said second set of data comprises creating a list of all keys, which are comprised in licenses related to said first persistent pseudonym.

8. A method according to claim 7, wherein said creating said second set of data comprises encoding, by a hash function, each of said keys together with a constant, which constant is also comprised in said second set of data.

9. A method according to claim 1, wherein a persistent pseudonym and a request for a license for requested information are received said method further comprising:
using said received persistent pseudonym, associated with a user identity device, when encrypting values representing a symmetric key, identifiers of said requested information and rights associated with said user identity device and said requested information; and
creating a license, wherein said encryption is comprised in said created license.

10. A method according to claim 1, wherein said verifying a license when accessing requested content comprises determining that said license identifying data, comprised in said license, is valid by comparing it to said second set of data comprised in said certificate.

11. A method according to claim 1 wherein said second license equals said first license, further comprising:
receiving said first license at a first user identity device, which comprises distributing said first license to said second user identity device; and
receiving a set of persistent pseudonyms and a second license further comprises receiving said set and said license from said second identity device.

12. A method according to claim 1 and wherein said first license is an anonymous license, said second license is equal to said first license, and license managing device is associated with a third set of data indicating which anonymous licenses that are valid, further comprising:
receiving, at a license managing device, data representing requested information and corresponding rights, and further comprises receiving this by an anonymous channel; creating said first license further comprises creating an anonymous identification, and encrypting said identification with a key corresponding to said received information and said rights;
receiving said first license at said first license managing device, further comprises distributing said first license to said second user identity device; and
receiving, at said license managing device, at least one persistent pseudonym and a second license further comprising receiving these from said second user identity device, modifying said third set of data such that it indicates that said second license is no longer valid.

13. A method according to claim 5, wherein said second license corresponds to said first license when it is unblinded, further comprising:
receiving said first license, at said first user identity device, further comprises generating and blinding a secret identifier at said first identity device, receiving at said license managing device, said first license, said persistent pseudonym, a request to cancel said first license, a request for an anonymous license for requested information and said blinded secret identifier, creating a certificate associated to said first persistent pseudonym, sending said certificate to the license managing device, generating at said license managing device said anonymous license for said requested information based on said blinded identifier, receiving said anonymous license at said first user identity device, unblinding, at said first user identity device, said anonymous license, and receiving at said second user device said unblinded anonymous license; and
receiving, at said license managing device, a set of persistent pseudonyms and said unblinded anonymous license further comprises receiving these from said second user identity device.

14. A method according to claim 1, wherein said first license indicates the rights which are distributable for said requested information, and wherein:
said receiving a set of persistent pseudonyms further comprises receiving data indicating which rights each license in said set of licenses is to be associated with;
said creating a set of licenses further comprises associating at least one of said licenses with more restrictive rights compared to said distributable rights.

15. An information system for distribution of information, while keeping the identity of a user secret, comprising:
a first user identity device, comprising a persistent pseudonym;
a set of user identity devices, comprising at least one user identity device;
a license managing device, arranged to receive data representing requested information and corresponding rights from said first user identity device, to create a first license, to send said first license to said first user identity device, to receive a second license based on said first license and a set of persistent pseudonyms comprising at least one persistent pseudonym, to create a set of licenses wherein said set comprises a third license for each user identity device, which device is associated with the respective persistent pseudonym comprised in said second set of persistent pseudonyms, and to distribute each of said licenses comprised in said set of licenses to its corresponding user identity devices;
an identity managing device, arranged to receive a persistent pseudonym, create a certificate and to send a certificate to said user identity device comprised in said set of user devices.

16. An information system according to claim 15, wherein
said first user identity device belongs to a first domain of user identity devices, and each user identity device comprised in said set of user identity devices belongs to said first domain;
said second license equals said first license;
said license managing device comprises a first license managing device and a second managing device;
said set of persistent pseudonyms comprises persistent pseudonyms all belonging to said first domain;
said first license managing device is arranged to receive said data representing requested information and corresponding rights from said first user identity device, to create said first license and to send said first license to said first user identity device;
said second license managing device is arranged to receive said set of persistent pseudonyms and said second license, which is equal to said first license, to create said set of licenses to distribute each of said licenses comprised in said set of licenses to its corresponding user identity devices.

17. A system according to claim 17, wherein said first license managing device is further arranged to receive said first persistent pseudonym; and
said master license is an encryption with said first persistent pseudonym, which encryption comprises a first symmetric key, said rights and said data representing said requested information.

18. A system according to claim 15, further comprising:
a first set of data indicating which licenses that are valid; wherein
said license managing device is further arranged to receive a license identification and a request to cancel corresponding license, to modify said first set of data such that it indicates that said license corresponding to said license identification is cancelled, to receive a persistent pseudonym from said identity managing device, create a second set of data indicating which licenses, related to said first persistent pseudonym, that are valid, and to said second set of data to said identity managing device;
said identity managing device is arranged to receive a first persistent pseudonym from said first user identity device, to said first persistent pseudonym to said license managing device, to receive said second set of data from said license managing device, to create a certificate which comprises said second set of data and to send said created certificate to said first user identity device.

19. A system according to claim 15, wherein
said first license is an anonymous license;
said second license is equal to said first license;
said license managing device is associated with a third set of data indicating which anonymous licenses that are valid; and wherein
said license managing device is further arranged to receive data representing requested information and corresponding rights through an anonymous channel, to create an anonymous identification and to create an anonymous license by encrypting said anonymous identification with a key corresponding to said received information and rights, to send said anonymous license to said first user device, to receive said anonymous license from said second user identity devices and to modify a third set of data such that it indicates that said anonymous license is cancelled.

20. A system according to claim 15, wherein said second license corresponds to a generated anonymous license, after said anonymous license has been unblinded;
said first user identity device is arranged to generate and blind
a secret identifier, to send said blinded secret identifier to said license managing device, to receive an anonymous license from said license managing device, to unblind said anonymous license and to send said unblinded license to said second user device;
said license management device is further arranged to receive said blinded secret identifier and said first license, to cancel said first license, to generate an anonymous license corresponding to said blinded secret identifier, to send said anonymous license to said first identity device, to receive said unblinded license form said second user identity devices, to cancel said unblinded license, to generate said third license and to distribute said third license to said second user identity device.
